(19) United States
(12) Patent Application Publication
(10) Pub. No.: US 2025/0303967 A1
(43) Pub. Date: Oct. 2, 2025

(54) Camera-Wing-System, Vehicle Therewith and Method to Operate the Same

(71) Applicant: Motherson Innovations Company Limited, London (GB)

(72) Inventors: Alexander SLAMA, Stuttgart (DE); Mariusz MADRY, Stuttgart (DE); Romeo WIECZOREK, Stuttgart (DE); Matthias KOLLER, Stuttgart (DE)

(21) Appl. No.: 19/234,481

(22) Filed: Jun. 11, 2025

Related U.S. Application Data
(63) Continuation-in-part of application No. 18/989,527, filed on Dec. 20, 2024.
Application No. 18/989,527 is a continuation of application No. 17/983,584, filed on Nov. 9, 2022, now Pat. No. 12,208,743.

(30) Foreign Application Priority Data
Dec. 2, 2021 (DE) 10 2021 131 823.8

(51) Int. Cl. B60R 1/28; B60R 11/00; B60R 11/04; G01S 17/86; G06T 7/50; G06T 7/73; G06V 10/46; G06V 20/56; H04N 7/18; H04N 23/695

(52) U.S. Cl. CPC B60R 1/28; B60R 11/04; G06T 7/50; G06T 7/73; G06V 10/462; G06V 20/56; H04N 7/183; H04N 23/695; B60R 2011/0085; G01S 17/86; G06T 2207/30252

(57) ABSTRACT

Systems and methods are provided for a camera-wing-system that includes a camera, an electronic control unit (ECU) coupled to the camera, and an image section. The camera is configured to record a field of view (FOV) in an area surrounding the vehicle. The ECU is configured to determine a region of interest within the FOV. The image section is configured to display a presented view to a driver of the vehicle. The ECU is configured to update the presented view to include the region of interest based on a driving situation of the vehicle. The presented view includes an enhanced view that depicts the region of interest.

### CROSS-REFERENCE TO RELATED APPLICATION

This application is a continuation-in-part of U.S. patent application Ser. No. 18/989,527, filed Dec. 20, 2024, which is a continuation of U.S. patent application Ser. No. 17/983,584, filed on Nov. 9, 2022, which claims priority to German Application No. DE 10 2021 131 823.8, filed on Dec. 2, 2021, each of which are incorporated herein by reference in their entirety.

### FIELD

The present disclosure relates generally to vehicle display systems and more particularly to displaying an enhanced view of a region of interest within a camera wing system.

### BACKGROUND

The statements in this section merely provide background information related to the present disclosure and may not constitute prior art.

Current trailer tracking systems have difficulty identifying a rear end of a trailer system. As such, the current tracking systems are incapable of accurately tracking and monitoring the end of the trailer in order to update the field of view to ensure the end of the trailer is always in view of the tracking system. An example object of this disclosure is to effectively track and monitor the rear end of the trailer or vehicle and accordingly update an image section and overcomes at least some of the stated problems above.

Furthermore, some cameras and viewing systems for motor vehicles provide limited viewing options to drivers of the vehicles. For example, some systems may include limited viewing options of some vehicle areas during poor weather or viewing conditions, such as in cases of precipitation and dark environments (e.g., nighttime). Furthermore, some viewing systems depict areas of concern for a driver (e.g., areas particularly susceptible to collision) in a relatively small area of a display compared with other detected objects or surroundings. In some driving situations, such as driving in reverse, it is difficult for the driver to see the areas of concern due to the relatively small depiction and/or a poor image quality (e.g., low resolution) of the area of concern.

Moreover, in some viewing systems, areas of concern are difficult or impossible to see due to, for example, haze, a low lighting condition, rain, snow, or the small depiction of the area of concern within the viewing system. The areas of concern may be more difficult to view, for example, depending on the driving situation of the vehicle, such as lane change, parking, or entering parking spaces or halls. In some instances, simply enlarging the area of concern will not improve other characteristics of the depiction of the area of concern (e.g., low resolution).

This is because some systems do not provide improved or increased resolution depending on the object or area being recorded. It may be advantageous to provide an improved view to a driver of a vehicle that enhances views of identified areas of concern within a surrounding of the vehicle.

### SUMMARY

An example object of the present disclosure is to provide a camera-wing-system for a vehicle solving at least some of the disadvantages of the prior art, especially a system to update image section of the vehicle based on change in angle of the trailer/vehicle.

Systems and methods are provided for a camera-wing-system that includes a camera, an electronic control unit (ECU) coupled to the camera, and an image section. The camera is configured to record a field of view (FOV) in an area surrounding the vehicle. The ECU is configured to determine a region of interest within the FOV. The image section is configured to display a presented view to a driver of the vehicle. The ECU is configured to update the presented view to include the region of interest based on a driving situation of the vehicle. The presented view includes an enhanced view that depicts the region of interest.

In another example, a method includes receiving a video stream of a FOV of an area surrounding a vehicle from a camera. A region of interest within the FOV is determined. An image enhancement algorithm is applied to the region of interest to form an enhanced view. A presented view is displayed to a driver of the vehicle. The presented view includes the enhanced view.

Example embodiments include a camera-wing-system for the vehicle comprising at least one camera for recording a field of view, FOV, in a scene at least around a rear part of the vehicle, wherein a presented view is provided to a driver of the vehicle as a part of the FOV, the camera-wing-system is adapted to update an image section from the presented view of the at least one camera to another presented view different from the previous presented view to keep a point of interest of the rear part of the vehicle, preferably a trailer as the rear part of the vehicle, within the presented view provided to the driver regardless of a driving situation of the vehicle, and the image section is updated basis on a distance between the at least one camera and a geometric calculation of a triangle between a center of rotation, a salient point, and the at least one camera of the vehicle.

The term “camera-wing-system” denotes the component arranged at the side of the vehicle at a position suitable to record at least the rear view from the vehicle. The position of the camera-wing-system might be the same as for conventional vehicle mirror systems. Due to the possibility to display the recorded scenery inside the vehicle on a display, the camera-wing-system might be arranged at a position outside the field of view of the driver of the vehicle. The wing system comprises an arm or wing on which the camera is installed so that the camera is positioned over the wing somewhat away from the chassis of the vehicle so that the chassis of the vehicle cannot restrict the field of view of the camera, or can only partially restrict the field of view of the camera.

The term “vehicle” denotes any motor driven vehicle driven be a driver, where the driver requires information about persons, other vehicles or objects in the near surrounding of the vehicle to be able to drive safety. As an example, motor vehicles are cars or trucks, especially when pulling trailers. The term “driving situation” denotes the direction, in which the vehicle is currently driven. The common driving situation is driving straight ahead, while cornering is a different driving situation. Other driving situations include reversing, parking, or turning. The latter can be a special form of cornering. Depending on the driving situation, the requirements for the illumination system change due to changing sceneries of interest to be observed by the driver via the camera-wing-system.

The term “camera” denotes any device capable of recording or recognizing the environment of a vehicle and of displaying this recognized or recorded environment in an image so that a driver can process the environment as driving information based on the image display. The camera might be an infrared (IR) camera. IR cameras will increase the visibility of objects during nighttime. Especially CCD or CMOS cameras can detect near infrared (NIR) wavelengths not detectable be the human eye. The NIR denotes light with wavelengths within a spectral range between 700 nm and 1400 nm. NIR can rely on the sun's invisible infrared (IR) radiation during daytime operation. During nighttime operation, the NIR light may be provided by IR light sources of the illumination system illuminating the scenery in the field of view, where the reflected light is recorded by the camera. To be able to be used during nighttime, the camera must be sensitive at least to a part of the spectrum of the light emitted by the light sources of the illuminating system.

The term “field of view” denotes the extent of the observable world that is “seen” (recorded) at any given moment by the camera. The field of view relates to an angular field of view specified in degrees in vertical and horizontal direction. The recorded field of view can be displayed to the driver by camera-wing-system on a corresponding display connected to the camera-wing-system. In some embodiment the display might be part of the camera-wing-system. The field of view is directed to the areas of interest for the driver to be able to drive the vehicle safety without endangering other persons, objects, or vehicles in the field of view, or damaging the own vehicle. The areas of interest might by the rear and side views of the vehicle, preferably on both sides of the vehicle as well as front views.

The term “scenery” denotes the observable world, which can be seen by the driver when using the camera-wing-system. The scenery might be only a part of the observable world in the field of view. In daytime operation, the overall brightness might be enough to observe the complete observable world in the field of view of the camera. In nighttime operation the scenery might be restricted to the parts of the observable world, which are illuminated by the illumination system. Objects not being illuminated might be not recorded by the camera due to the too low level of light being reflected from these “dark” objects.

In an embodiment the camera-wing-system further comprises a ToF sensor adapted to measure said distance, wherein ToF sensor is configured outside a housing that accommodates the at least one camera of the camera-wing-system.

In an embodiment the camera-wing-system having the at least one camera and the ToF sensor is configured within said housing of the camera-wing-system. In an embodiment the camera-wing-system having the at least one camera is adapted to capture the FOV as well as measure said distance.

In yet another embodiment the camera-wing-system having the salient point of the trailer is the point of interest which is a detected prominent part of the vehicle.

In yet embodiment the camera-wing-system having the point of interest is a detected prominent part of the vehicle.

In yet another embodiment the camera-wing-system having the detected distinctive part of the vehicle is at least one of a marking and a unique feature attached to the vehicle.

In yet another embodiment the camera-wing-system having the unique feature includes at least one of sticker, a side light, and a rear-most axle of the vehicle.

In yet another embodiment the camera-wing-system having the salient point is detected by a suitable optical recognition software installed and executed on an electronic control unit of the camera-wing-system.

In yet another embodiment the camera-wing-system having the system requires initialization after a straight-ahead situation.

In yet another embodiment the camera-wing-system having the system requires initialization after a restart or after attaching a new trailer.

In yet another embodiment the camera-wing-system having the system starts initialization only when detecting a straight-ahead situation based on a speed data and a steering angle of the vehicle in a timeframe.

In yet another embodiment the camera-wing-system having the information pertaining to any change in the ignition state is recorded, and in such an event re-initialization is performed to measure the distance to salient points.

In yet another embodiment the camera-wing-system having the system detects the straight-ahead situation in an event distance between the first camera to at least one salient point located on that side and distance between the second camera to at least one salient point located on that side is at a predefined distance calibrated for straight ahead situation.

Embodiments further relate to a vehicle comprising at least one camera-wing-system.

Example embodiments relate to a method to operate a camera-wing-system mounted on a vehicle comprising at least one camera, comprising following steps: recording a field of view by at least one camera in a scene at least around a rear part of the vehicle, wherein providing a presented view to a driver of the vehicle as a part of the field of view, adapting the camera-wing-system to update an image section from the presented view of the at least one camera to another presented view different from the previous presented view to keep a point of interest of the rear part of the vehicle, preferably a trailer as the rear part of the vehicle, within the presented view provided to the driver regardless of a driving situation of the vehicle, and updating the image section is performed basis on a distance between the at least one camera and a geometric calculation of a triangle between a center of rotation, a salient point, and the at least one camera of the vehicle.

Example embodiments relate to a method to operate a tracking system comprising the method of operate a camera-wing-system as described above. Details of the tracking system and its operation are described e.g. with respect to FIG. 2.

It should be noted that the features set out individually in the following description can be combined with each other in any technically advantageous manner and set out other forms of the present disclosure. The description further characterizes and specifies the present disclosure in particular in connection with the Figures.

### DESCRIPTION OF THE DRAWINGS

In order that the disclosure may be well understood, there will now be described various forms thereof, given by way of example, reference being made to the accompanying drawings, in which:

FIG. 1a depicts a schematic view of a trailer and camera-wing-system, in accordance with some embodiments.

FIG. 1b depicts another schematic view of the trailer and camera-wing-system, in accordance with some embodiments.

FIG. 1c depicts yet another schematic view of the trailer and camera-wing-system, in accordance with some embodiments.

FIG. 1d depicts yet another schematic view of the trailer and camera-wing-system, in accordance with some embodiments.

FIG. 2 depicts a method for time of flight trailer tracking to update an image section, in accordance with some embodiments.

FIG. 3 depicts a sub-process for determining the salient point of the trailer and the distance from the salient point to an image capturing device, in accordance with some embodiments.

FIG. 4a depicts a diagram for determining the adjustment angle for an image capturing device for a semi-trailer using the front of the semi-trailer, in accordance with some embodiments.

FIG. 4b depicts an enlarged view of the diagram for determining the adjustment angle for an image capturing device for a semi-trailer using the front of the semi-trailer, in accordance with some embodiments.

FIG. 5 depicts a diagram for determining the adjustment angle for an image capturing device for a semi-trailer, in accordance with some embodiments.

FIG. 6 depicts a diagram for determining the adjustment angle for an image capturing device for a rigid trailer, in accordance with some embodiments.

FIG. 7 depicts a method of displaying a presented view to a driver, in accordance with some embodiments.

FIG. 8 depicts an enhanced view as a Picture-in-Picture view within a presented view, in accordance with some embodiments.

FIG. 9 depicts an enhanced view adjacent to a presented view, in accordance with some embodiments.

FIG. 10 depicts an enhanced view that is overlayed on a portion of a presented view that includes a region of interest, in accordance with some embodiments.

The drawings referred to in this description are not to be understood as being drawn to scale except if specifically noted, and such drawings are only exemplary in nature.

### DETAILED DESCRIPTION

The following description is merely exemplary in nature and is not intended to limit the present disclosure, application, or uses. It should be understood that throughout the drawings, corresponding reference numerals indicate like or corresponding parts and features.

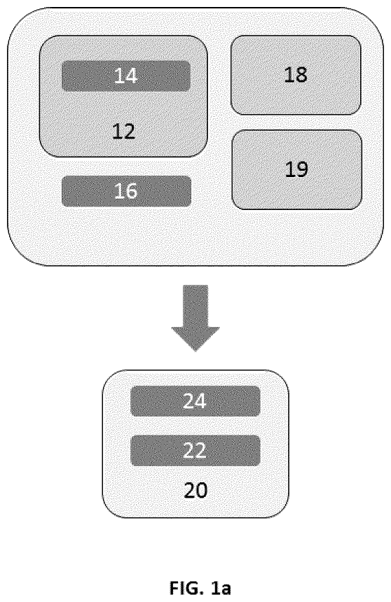

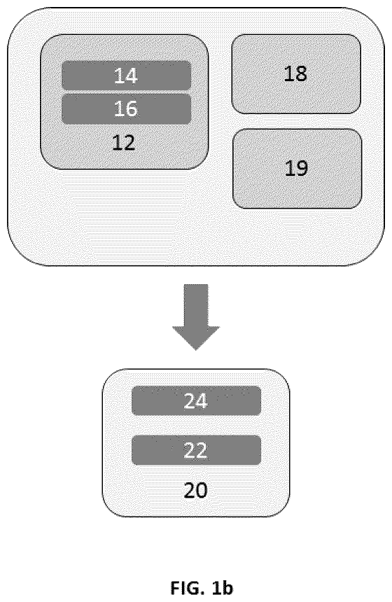

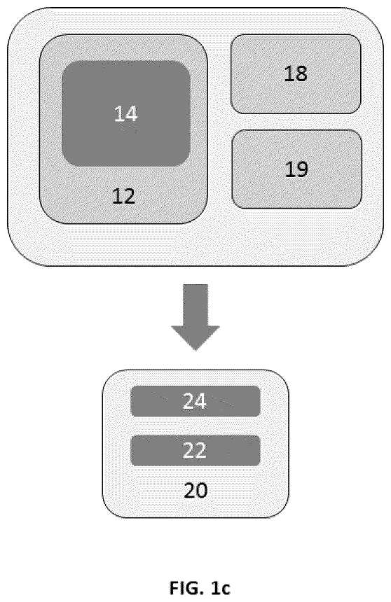

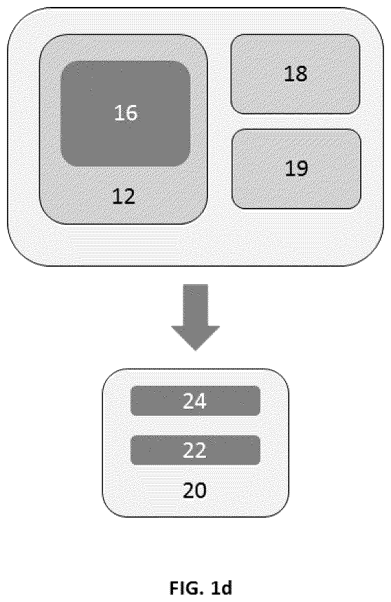

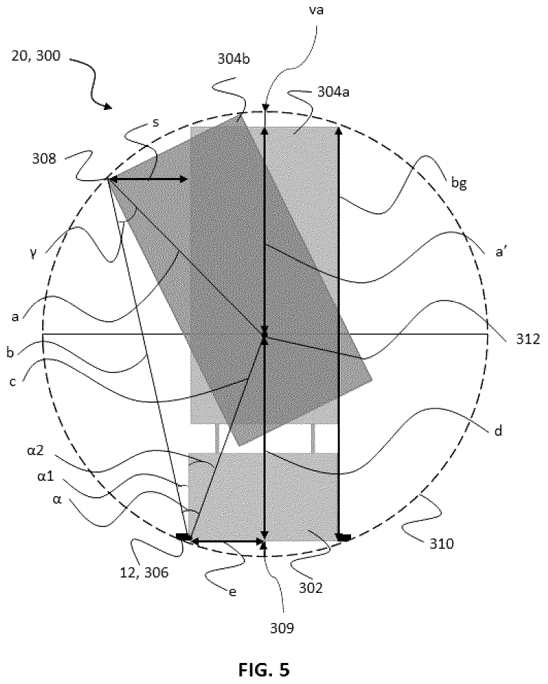

FIGS. 1a, 1b, 1c and 1d depict schematic views of a camera-wing-system 12 of a trailer 20 or vehicle 20. As illustrated in FIG. 1a, the camera-wing-system 12 comprised of at least one camera 14 configured within a housing of the camera-wing-system 12 and a time-of-flight (TOF) sensor 16 located outside or attached to said housing. The at least one camera 14 is configured to capture a field-of-view (FOV) while the TOF sensor 16 is configured to measure distance between the at least one camera 14 and a salient point (as depicted in FIG. 5 including other figures).

In another embodiment, as illustrated in FIG. 1b, the camera-wing-system 12 comprises the least one camera 14 and the ToF sensor 16, wherein the least one camera 14 and the ToF sensor 16 are configured within said housing of the camera-wing-system 12. The at least one camera 14 is configured to capture a field-of-view (FOV) while the TOF sensor 16 is configured to measure distance between the at least one camera 14 and a salient point (as depicted in FIG. 5 including other figures).

In yet another embodiment, as illustrated in FIG. 1c, the camera-wing-system 12 comprises the at least one camera 14 is configured to capture a field-of-view (FOV). Further, the at least one camera 14 is designed such that it is adapted to measure distance between the at least one camera 14 and a salient point (as depicted in FIG. 5 including other figures). The at least one camera 14 is configured within the housing of the camera-wing-system 12. In an embodiment, the light sensor of the at least one camera 14 may have a specification ranging from 0.1 megapixel to 100 megapixels.

In yet another embodiment, as illustrated in FIG. 1d, the camera-wing-system 12 comprises the TOF sensor 16 to measure distance between the at least one camera 14 and a salient point (as depicted in FIG. 5 including other figures). Further, the TOF sensor 16 is adapted to capture a field-of-view (FOV). The TOF sensor 16 may have more pixels to cater to the need of capturing light signals thrown by itself as well as external light signal similar to an image sensor. In an embodiment, the light sensor of the at TOF sensor 16 may have a specification ranging from 5 pixels to 0.5 megapixel.

The camera-wing-system 12 further comprises an electronic control unit (ECU) 18 and an image section 19. In a scenario wherein only camera 14 is a part of the camera-wing-system 12, the camera 14 is adapted to work as a regular image sensor to capture the FOV as well as measure distance similar to a TOF sensor 16. In similar way, a scenario, wherein only TOF sensor 16 is a part of the camera-wing-system 12, the TOF sensor 16 is configured with more pixels such that it is adapted to work as a regular image sensor to capture the FOV as well as measure distance similar to a TOF sensor 16.

The salient point 24 of the trailer is the point of interest which is a detected prominent part of the vehicle 20. Systems and methods for obtaining the point of interest (e.g., region of interest) are described in U.S. patent application Ser. No. 17/511,161, filed Oct. 26, 2021, which is hereby incorporated by reference in its entirety. The point of interest is a detected prominent part of the vehicle 20. For vehicles having a static (e.g., unmoving) end, such as a non-movable or connectable trailer, the identification of a point of interest may be unnecessary. In such examples, displaying enlarged depictions of the point of interest may be optional. For vehicles with movable trailers, the point of interest may be in an area at or near the end of the trailer. Furthermore, the point of interest may differ depending on an operation of the vehicle (e.g., driving situation), as described below. The point of interest may be determined by a trailer end detection algorithm or by a point of interest prediction algorithm. The point of interest may also be identified by head position or eye orientation in relation to a position of the display, as described further below. Furthermore, the point of interest may be identified by a manual interaction of the driver with the camera wing system 12.

The detected distinctive part of the vehicle 20 is at least one of a marking and a unique feature attached to the vehicle 20. Further, the unique feature includes at least one of sticker, a side light, and a rear-most axle of the vehicle 20. The salient point 24 is detected by a suitable optical recognition software installed and executed on the ECU 18 of the camera-wing-system 12. The system 12 requires initialization after a straight-ahead situation. The system 12 requires initialization after a restart or after attaching a new trailer. The camera-wing-system 12 according to any one of the preceding claims, wherein the system 12 starts initialization only when detecting a straight-ahead situation based on a speed data and a steering angle of the vehicle 20 in a timeframe. The straight-ahead situation described herein-above refer to a situation wherein the cabin and the trailer are inline.

The camera-wing-system 12 according to claim 12, wherein the information pertaining to any change in the ignition state is recorded, and in such an event re-initialization is performed to measure the distance to salient points.

The camera-wing-system 12 according to any one of the preceding claims, wherein the system 12 detects the straight-ahead situation in an event distance between the first camera 12 to at least one salient point 24 located on that side and distance between the second camera 12 to at least one salient point 24 located on that side is at a predefined distance calibrated for straight ahead situation

In yet another embodiment, the camera-wing-system 12 for a vehicle 20 comprising at least one camera 14 for recording a field of view in a scene at least around a rear part of the vehicle 20. A presented view is provided to a driver of the vehicle 20 as a part of the field of view, the camera-wing-system 12 is adapted to update an image section 19 from the presented view of the at least one camera 14 to another presented view different from the previous presented view to keep a point of interest of the rear part of the vehicle 20, preferably a trailer 300, 400 as the rear part of the vehicle 20, within the presented view provided to the driver 60 regardless of a driving situation of the vehicle 20. The image section 19 is updated basis on a distance between the at least one camera 14 and a geometric calculation of a triangle between a center of rotation 312, a salient point 24, and the at least one camera 14 of the vehicle 20.

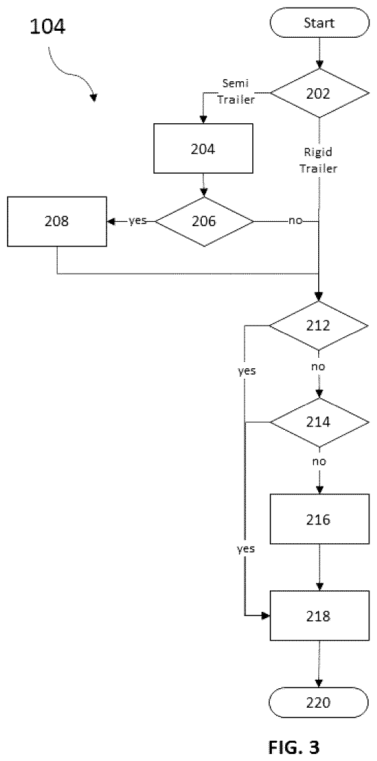

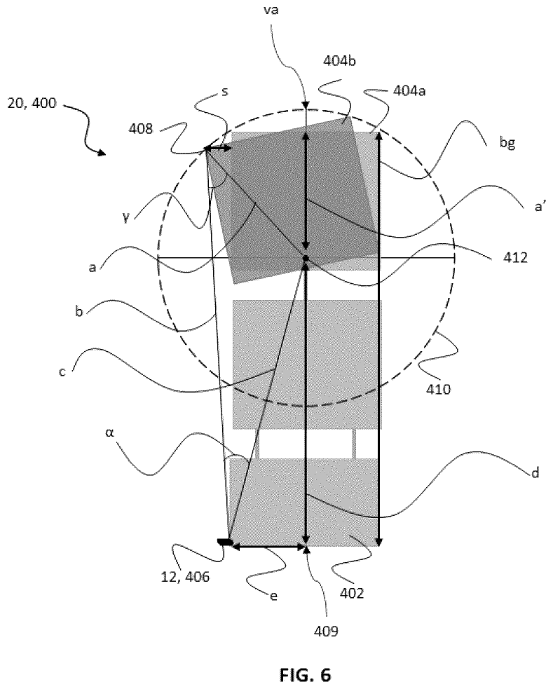

The trailer 20 may either be a semi-trailer 300 or a rigid trailer 400, as seen in FIG. 5 and FIG. 6 respectively. The trailer 20 is comprised of a marking point 22 and a salient point 24. The marking point 22 is located along a leading edge 305 of the semi-trailer 300, as seen in FIG. 3. The salient point 24 may include but not limited to one or combination of the marking point 22, the rear wheel on the trailer 20, a sticker placed near the rear end of the trailer 20, and a side light located near the rear of the trailer 20.

The camera-wing-system 12 or a ToF array without MEMs technology can be used as a solid state sensor to detect the trailer 20 for the semi-trailer 300 or the rigid-trailer 400 location to update the image section 19. By having a multitude of pixels, the at least one camera 14 is able to recognize the trailer 20 according to distinctive points via a software performing an algorithm as described in this foregoing disclosure. The angle of the trailer 20 can be determined based on the distance from the at least one camera 14 or ToF sensor 16 to the salient point 24. The salient point 24 may be one or combination of the rear wheel on the trailer 20, a sticker placed near the rear of the trailer 20, or a side light located near the rear of the trailer 20. The angle of the trailer 20 may also be determined based on the distance from the at least one camera 14 or ToF sensor 16 to the marking point 22 located along a front edge of the trailer 20.

Active lighting may be used so that the camera-wing-system 12 is able to recognize the trailer 20 in dark places with minimum to no external lighting, or at night. Additionally, the camera-wing-system 12 is able to scan for blind spots, the rear view, objects and their distance, and approach speeds. The measurement of the distance to the salient point 24 is calculated, at least once, at an angle of approximately zero degrees before the angle of the trailer 20 is determined. When the trailer 20 has an angular offset of approximately ten degrees or greater the salient point 24 is sufficiently visible and can be recognized to measure the distance. Measurements when the angular offset is less than ten degrees can be performed if the salient point 24 can be sufficiently recognized.

The camera-wing-system 12 is also able to perform a double measurement to the salient point 24 and the marking point 22 on the semi-trailer 300 to ascertain the angle. By performing the measurement from both sides simultaneously the distance of the salient point 24 and the marking point 22 can be compared to determine the angle. This enables the camera-wing-system 12 to precisely determine when the trailer 20 is straight and the length of the vehicle or the distance to the salient point 24.

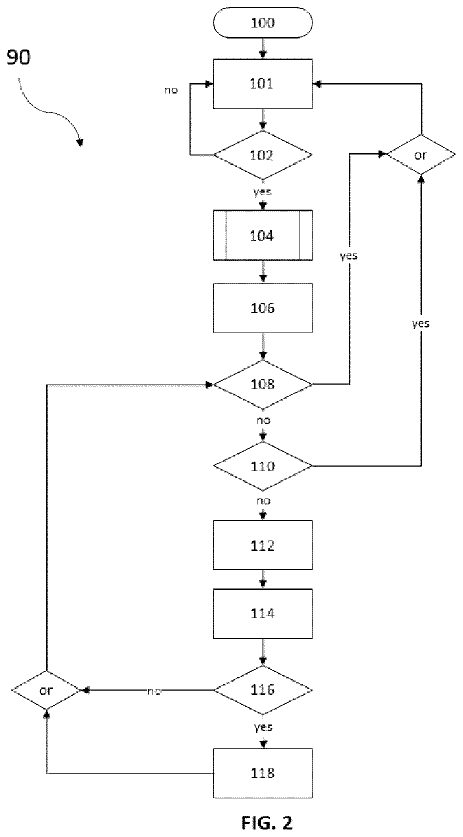

FIG. 2 depicts a method 90 for time of flight (ToF) trailer tracking to update an image section. The method 90 uses a method 100 to operate a camera-wing-system 12 for the trailer 20 to update the image section 19, as seen in FIGS. 1a, 1b, and 1c. The method 100 comprises following steps: recording a field of view by at least one camera 14 in a scene at least around a rear part of the vehicle 20; providing a presented view to a driver of the vehicle 20 as a part of the field of view; adapting the camera-wing-system 12 to update an image section 19 from the presented view of the at least one camera 14 to another presented view different from the previous presented view to keep a point of interest of the rear part of the vehicle 20, preferably a trailer 300,400 as the rear part of the vehicle 20, within the presented view provided to the driver 60 regardless of a driving situation of the vehicle 20; and updating the image section is performed basis on a distance between the at least one camera 14 and a geometric calculation of a triangle between a center of rotation 312, a salient point 24, and the at least one camera 14 of the vehicle 20.

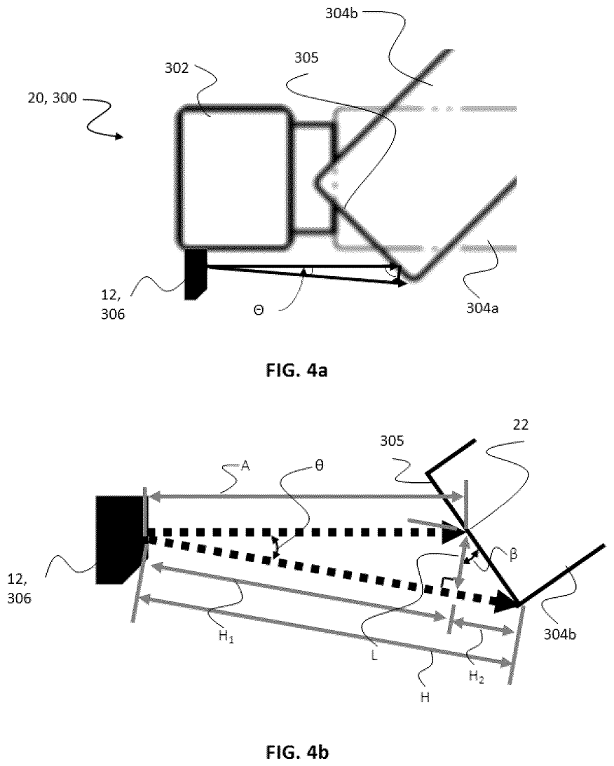

In a step 101 of the method 90 the steering angle and speed are measured. In a step 102 if the steering angle is greater than five degrees or if the speed is zero the camera-wing-system 12 reverts back to the step 101 to measure the steering angle and speed. If the steering angle is less than five degrees and the speed is greater than zero for five seconds the camera-wing-system 12 proceeds to a sub-process step 104. The sub-process 104 is used to determine the salient point 24, and will be further discussed in FIG. 3. In a step 106, the distance from the step 104 is logged into the memory within the EDU 18. Then in a step 108, the camera-wing-system 12 checks to see if the ignition is off. In an event the ignition is off, the camera-wing-system 12 reverts back to step 101 to measure the steering angle and speed. Alternatively, if the ignition is on, the camera-wing-system 12 proceeds to a step 110. In the step 110, the camera-wing-system 12 checks to see if the trailer 20 signal is interrupted. If the trailer 20 signal is interrupted, the camera-wing-system 12 reverts back to step 101 to measure the steering angle and speed. If the trailer 20 signal is not interrupted, the camera-wing-system 12 proceeds to a step 112 where the distance to the salient point 24 is measured. Once the distance is measured a trailer angle a is calculated in a step 114. Further, as indicated in FIG. 4b, helix angle ß can be calculated for a specific type of trailer/vehicle. Here are two different methods of angle determination in 114. The described method is the determination of the angle α. However, the determination of the angle β can also be used. To choose between α and β, it can be an OR or an AND/OR operation. The method to determine B has the advantage that it is closer and therefore has advantages in bad weather conditions, but it is not possible with all vehicle types, except for semitrailers. Also, the two methods to determine α or β can also check each other.

In a step 116 if the trailer angle a is less than ten degrees, the camera-wing-system 12 reverts back to step 101 to measure the steering angle and speed. If the trailer angle α is greater than ten degrees, the camera-wing-system 12 progresses to a step 118. In the step 118, the camera-wing-system 12 updates the image section 19 accordingly to ensure the salient point 24 is visible within the image section 19.

FIG. 3 depicts the sub-process 104 to determine the salient 24 as seen in FIG. 5 and FIG. 6. In a step 202, the camera-wing-system 12 determines if the vehicle is the semi-trailer 300 or the rigid-trailer 400. If the vehicle is the semi-trailer 300 the camera-wing-system 12 progresses to step 204 where the camera-wing-system 12 determines the marking point 22 of the semi-trailer 300. Once the marking point 22 is determined, the camera-wing-system 12 determines if a leading edge 305, as seen in FIG. 4a, can be detected on the semi-trailer 300 in a step 206. If the leading edge 305 is detected a helix angle B is calculated in step 208. Once the helix angle β is calculated or if the leading edge 305 is not detected in step 206, the camera-wing-system 12 progresses to step 212. In step 212, the camera-wing-system 12 determines if there is a sticker located at the salient point 24. The sticker is optimized to reflect the wavelength of the camera-wing-system 12 illumination, with the preferred wavelength being in the near infrared range NIR. The stickers reflect the infrared light emitted by the camera-wing-system 12. If there is a sticker the camera-wing-system 12 progresses to a step 218 where the distance from the at least one camera 14 to the salient point 24. The distance is then sent to initialization in a step 220. If a sticker is not detected in step 212, the camera-wing-system 12 checks for a side light at the salient point 24 in step 214. If there is a side light the camera-wing-system 12 progresses to a step 218 where the distance from the at least one camera 14 to the salient point 24. The distance is then sent to initialization in a step 220. If the side light is not detected, the camera-wing-system 12 detects the wheels rearmost axel at the salient point 24 in step 216. The Camera-wing-system 12 then progresses to a step 218 where the distance from the at least one camera 14 to the salient point 24. The distance is then sent to initialization in a step 220.

If the vehicle is a rigid-trailer system 400 the ToF tracking system progresses to step 212. In step 212 the camera-wing-system 12 determines if there is a sticker located at the salient point 24. If there is a sticker the camera-wing-system 12 progresses to a step 218 where the distance from the at least one camera 14 to the salient point 24. The distance is then sent to initialization in a step 220. If a sticker is not detected in step 212, the camera-wing-system 12 checks for a side light at the salient point 24 in step 214. If there is a side light, the camera-wing-system 12 progresses to a step 218 where the distance from the at least one camera 14 to the salient point 24. The distance is then sent to initialization in a step 220. If the side light is not detected, the camera-wing-system 12 detects the wheels rearmost axel at the salient point 24 in step 216. The camera-wing-system 12 then progresses to a step 218 where the distance from the at least one camera 14 to the salient point 24. The distance is then sent to initialization in a step 220.

FIG. 4a depicts a diagram for determining an adjustment angle β (helix angle) for the at least one camera 14 for the semi-trailer 300 using the front edge 305 of the semi-trailer 300. A semi-trailer cab 302 supports the at least one camera 14. In this form the at least one camera 14 is seen on only one side of the semi-trailer cab 302, but it may be located on either side or both sides of the semi-trailer cab 302. The semi-trailer 300 is able to be positioned into a first position 304a or a second position 304b. The semi-trailer 300 is in a first position 304a when a trailer angle θ is at an angle of less than five degrees. When the semi-trailer 300 is in a first position 304a the image capturing device 306 is unable to detect the leading edge 305. When a semi-trailer is in the second position 304b, the trailer angle θ is at an angle greater than five degrees and the at least one camera 14 is able to detect a leading edge 305.

FIG. 4b depicts an enlarged view of the diagram for determining the adjustment angle β for an at least one camera 14 for a semi-trailer 300 using the leading edge 305 of the semi-trailer 300. The at least one camera 14, and the camera-wing-system 12 imbedded therein, measures a first distance A. The first distance A corresponds to the distance from the at least one camera 14 to the marking point 22 along the leading edge 305 of the semi-trailer 300 in the second position 304b. A distance H is then measured from the at least one camera 14 to a second point along the leading edge 305 of the semi-trailer 300 in the second position 304b. The second point along the leading edge 305 is preferably the point at the edge of the semi-trailer 300. The at least one camera 14 is able to differentiate the pixels of when the leading edge 305 of the trailer 20 ends and uses that point to determine the distance H. The at least one camera 14 determines an angle θ using the marking point 22. A distance H₁ is then calculated using equation H₁=A cos θ. The distance H₁ corresponds to the distance from the at least one camera 14 to a point wherein a distance L perpendicularly intersects the distance H. The distance L extend from the marking point 22 to the distance H. A distance H₂ extends from where the distance L perpendicularly intersects the distance H to the second point along the leading edge 305. The distance H₂ is calculated using the equation H₂=H−H₁. The distance L is determined using L=A sin θ. The helix angle β is then determined using the equation

$$β = {tan}^{- 1} \frac{{H}_{2}}{L} .$$

FIG. 5 depicts a diagram for determining the trailer angle a for the at least one camera 14 for the semi-trailer 300 using the salient point 24. The ToF camera 12 is coupled to the semi-trailer cab 302. A distance bg measures the distance from the image capturing device 12 to the rearmost end of the semi-trailer 300 in the first position 304a. The distance bg is a known value. The semi-trailer 300 includes a center of rotation 312. The semi-trailer 300 pivots around the center of rotation 312 and the salient point 24 follows the theoretical curve of a circle of rotation 310. The center of rotation 312 is located at a vertical distance d along the central vehicle axis va to the central front end 309 of the semi-trailer 300 and a horizontal distance e (perpendicular to distance d) between the at least one camera 14 and the central front end 309. The vertical distance d and the horizontal distance e are known values. A distance a′ is the distance from the center of rotation 312 to the rearmost end of the semi-trailer 300 and is determined using the equation a′=bg−d. The distance a′ and the horizontal distance e are used in the following equation a=\sqrt{a′²+e²} to determine a distance a. The distance a measures from the center of rotation 312 to the salient point 24 located on the semi-trailer 300 in the second position 304b. A distance c is the distance from the at least one camera 14 to the center of rotation 312. The distance c can be determined using the equation c=\sqrt{d²+e²}. A distance b is the distance from the At least one camera 14 to the salient point 24, and is a measured value from the At least one camera 14. An angle γ is between distance b and distance a. The angle γ is determined using equation

$$γ = {cos}^{- 1} \frac{{( bg - d )}^{2} + {b}^{2} - ( {d}^{2} + {e}^{2} )}{2 cb} .$$

The trailer angle α is the angle between the distance b and the distance c and can be determined using equation

$$∝ = {cos}^{- 1} \frac{{c}^{2} + {b}^{2} - {a}^{2}}{2 cb} .$$

An angle α₂ measures the angle between distance c and the edge of the semi-trailer cab 302 and can be determined using equation

$${∝}_{2} = 90 ° - {tan}^{- 1} \frac{d}{e} .$$

An angle α₁ is the measurement between distance b and the edge of the semi-trailer cab 302. The angle α₁ is determined using equation ∝₁=∝−∝₂. The angle α₁ is the adjustment angle for the at least one camera 14. The distance s denotes the distance by which the trailer 300 is deflected perpendicular to the central vehicle axis va in the second position 304b from the track of the trailer 300 in comparison to the first position 304a

FIG. 6 depicts a diagram for determining the trailer angle a for the at least one camera 14 for the rigid-trailer 400 using the salient point 24. The rigid-trailer 400 is comprised of the rigid-trailer cab 402 that supports the at least one camera 14. The rigid-trailer 400 is able to be positioned in a first position 404a or a second position 404b. A distance bg measures the distance from the image capturing device 12 to the rearmost end of the rigid-trailer 400 in the first position 404a. The distance bg is a known value. The rigid-trailer 400 includes a center of rotation 412. The rigid-trailer 400 pivots around the center of rotation 412 and the salient point 24 follows the theoretical curve of a circle of rotation 410. The center of rotation 412 is located at a vertical distance d along the central vehicle axis va to the central front end 409 of the rigid-trailer 400 and a horizontal distance e between the at least one camera 14 and the central front end 409. The vertical distance d and the horizontal distance e are known values. A distance a′ is the distance from the center of rotation 412 to the rearmost end of the rigid-trailer 400 and is determined using the equation a′=bg−d. The distance a′ and the horizontal distance e are used in the following equation a=\sqrt{a′²+e²} to determine a distance a. The distance a measures from the center of rotation 412 to the salient point 24 located on the rigid-trailer 400 in the second position 404b. A distance c is the distance from the At least one camera 14 to the center of rotation 412. The distance c can be determined using the equation c=\sqrt{a′²+e²} . A distance b is the distance from the At least one camera 14 to the salient point 24, and is a measured value from the At least one camera 14. An angle γ is between distance b and distance c. The angle γ is determined using equation

$$γ = {cos}^{- 1} \frac{{( bg - d )}^{2} + {b}^{2} - ( {d}^{2} + {e}^{2} )}{2 cb} .$$

The trailer angle α is the angle between the distance b and the distance c and can be determined using equation

$$∝ = {cos}^{- 1} \frac{{c}^{2} + {b}^{2} - {a}^{2}}{2 cb} .$$

An angle α₂ measures the angle between distance c and the edge of the rigid-trailer cab 402 and can be determined using equation

$${∝}_{2} = 90 ° - {tan}^{- 1} \frac{d}{e} .$$

An angle α₁ is the measurement between distance b and the edge of the semi-trailer cab 302. The angle α₁ is determined using equation ∝₁=∝−α₂. The angle α₁ is the adjustment angle for the At least one camera 14. The distance s denotes the distance by which the trailer 400 is deflected perpendicular to the central vehicle axis va in the second position 404b from the track of the trailer 400 in comparison to the first position 404a.

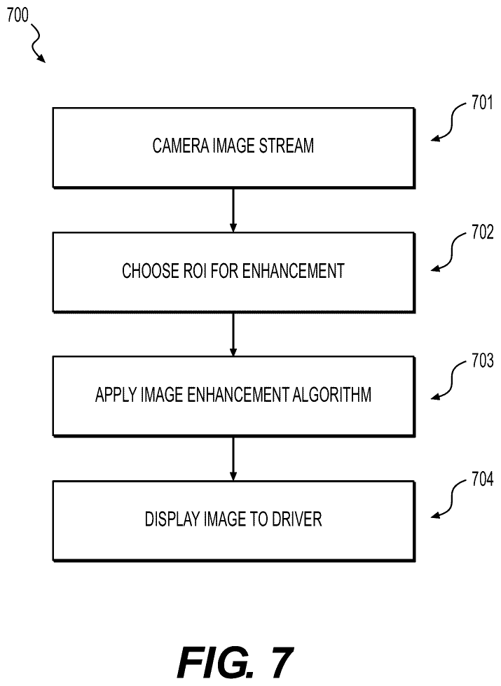

FIG. 7 depicts a method of displaying a presented view to a driver, in accordance with some embodiments. In the example shown in FIG. 7, the method 700 includes a first step 701 of obtaining a camera image stream. The camera image stream may be obtained, for example, by the camera 14. The method 700 includes a second step 702 of choosing a region of interest (e.g., point of interest). The region of interest may be determined by the ECU 18 and may be determined automatically based on the application of a computer algorithm. The region of interest may be, for example, an area that is likely to collide with another vehicle or object. For example, for vehicles with movable trailers, the region of interest may be an area at the end of the trailer 20.

The region of interest may be changed or updated depending on the driving situation of the vehicle 20. For example, when the vehicle 20 is backing up, an area on the vehicle 20 and near the end of the vehicle 20 may be determined to be the region of interest. When the vehicle 20 is switching lanes or moving laterally on a road, the region of interest may be near the side of the vehicle 20 and may even include areas not on the vehicle 20. In some examples, the region of interest may be determined based on a head position and an eye orientation of the driver of the vehicle 20 with respect to the presented view. The vehicle 20 may include appropriate sensors for determining the head position and the eye orientation of the driver. Furthermore, in some examples the region of interest is identified based on a manual interaction of the driver of the vehicle 20 with the camera wing system 12. For example, the driver may enter a user input (e.g., a button press or a touch screen press) specifying the region of interest.

The method 700 further includes a third step 703 of applying an image enhancement algorithm to an area of the image stream that includes the region of interest. The image enhancement algorithm may be applied by the ECU 18. The image enhancement algorithm may include algorithm-based super resolution, high dynamic range (HDR), haze removal, de-noising, image brightening, or any artefact removal (e.g., due to precipitation), or any combination thereof. In some examples, Advance Driver-Assistance Systems (ADAS) algorithms are applied to the area of the image stream that includes the region of interest. Based on the ADAS algorithms, hazards may be detected and highlighted. Furthermore, the camera wing system 12 may alert the driver based on detected hazards.

In some examples, outer boundary lines of portions of the vehicle or trailer 20 within the region of interest may be applied to the image stream. Furthermore, boundary lines may be applied to objects (e.g., hazards) surrounding the vehicle. In some examples, the objects are highlighted. The boundary lines and/or highlighting may be applied, for example, by the image enhancement algorithm. The objects and the boundary lines of the objects may be determined from sensors within the vehicle 20. For example, the vehicle 20 may include ultrasonic sensors or additional imaging sensors to identify the objects.

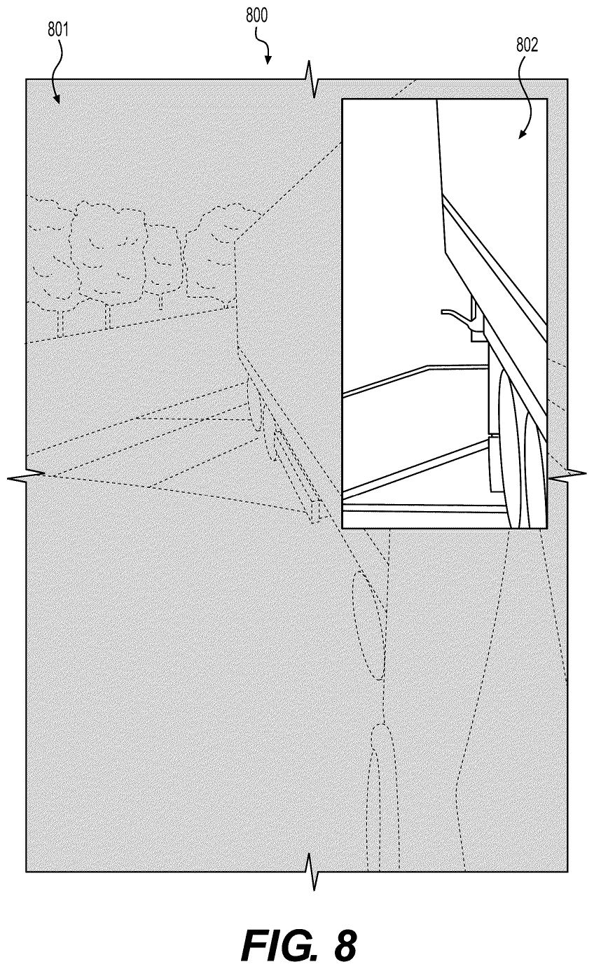

The method 700 includes a fourth step 704 of displaying the image to the driver of the vehicle 20. The image displayed to the driver may be the presented view that includes an area with the image enhancement algorithm applied to the region of interest. The region of interest may be enlarged with respect to the remaining presented view before being displayed within the area. Examples of the presented view displayed to the driver are shown in FIGS. 8, 9, and 10.

The systems and methods disclosed herein, including the method 700 depicted in FIG. 7, may include many advantages to drivers and users. For example, a driver may view an enlarged view of the region of interest (e.g., a region particularly relevant to the driver), while other areas within the presented view are not enlarged. Accordingly, a driver's attention may be drawn to the region of interest, while other areas of the presented view may appear substantially the same as they would appear on a reflective mirror. A driver may thus be able to accurately apply their perceptions (e.g., depth or distance perceptions) to the areas presented within the presented view. Furthermore, applying an image enhancement algorithm to only a portion of the image obtained at 701, as opposed to the entire image, may reduce a computational power required by the ECU 18.

The method 700 depicted in FIG. 7 may be automatically initiated based on conditions detected by one or more sensors within the vehicle 20. For example, the vehicle may include one or more sensors that generate controller area network (CAN) data, ambient light sensor data, weather data, or camera brightness data. The camera brightness data may be generated, for example, by the camera 14. The method 700 may be initiated based on one or more parameters (e.g., brightness) detected by the one or more sensors passing a predetermined threshold (e.g., decreasing below a predetermined brightness threshold).

Furthermore, the method 700 may be initiated based on the driving situation of the vehicle 20. For example, the method 700 may be initiated based on an intended lane change. Such an intended lane change may be determined, for example, based on the driver setting his or her turn signal. The driving situation may further include driving in curves (e.g., based on a steering wheel of the vehicle turning more than a predetermined amount), driving in reverse, parking, and/or entering garages, halls, or buildings. In some examples, the method 700 may be initiated based on a user input from the driver (e.g., pressing a physical button within the vehicle 20).

FIG. 8 depicts an enhanced view as a Picture-in-Picture (PiP) view within a presented view, in accordance with some embodiments. As shown in FIG. 8, the enhanced view 802 is displayed in the upper right corner of the presented view 800. The enhanced view 802 depicts an enlarged view of the region of interest (e.g., the back end of the trailer). The enhanced view 802 may be generated by the image enhancement algorithm, as described above. For example, the enhanced view 802 may include an increased image resolution compared with the resolution in a surrounding area 801 of the presented view 800. Furthermore, the enhanced view 802 may include a brighter view compared with the brightness of the surrounding area 801. The PiP enhanced view 802 depicted in FIG. 8 may displayed, for example, when the vehicle 20 is in reverse (e.g., “backing up”).

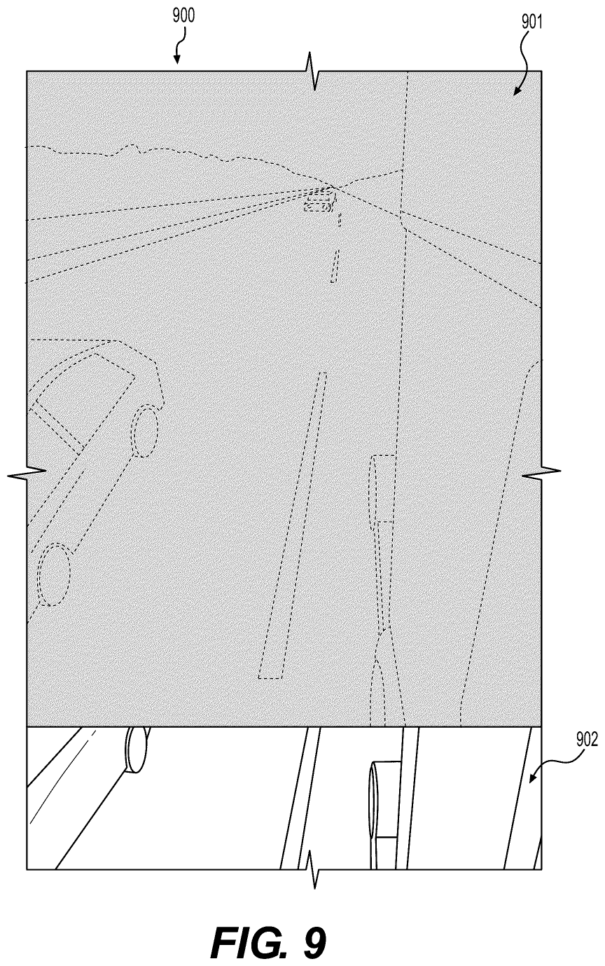

FIG. 9 depicts an enhanced view adjacent to a presented view, in accordance with some embodiments. As shown in FIG. 9, the enhanced view 902 may depict the region of interest and may appear at a border of the presented view 900. In the example shown in FIG. 9, the enhanced view 902 appears at a lower boundary of the presented view 900. In some examples, the enhanced view may appear at other boundaries (e.g., upper, left, right) of the presented view 900. Furthermore, the enhanced view 902 may include an increased resolution or brightness compared with the surrounding area 901 of the presented view 900. The enhanced view 902 depicted in FIG. 9 may be displayed to the driver, for example, when the vehicle 20 is performing a lane change.

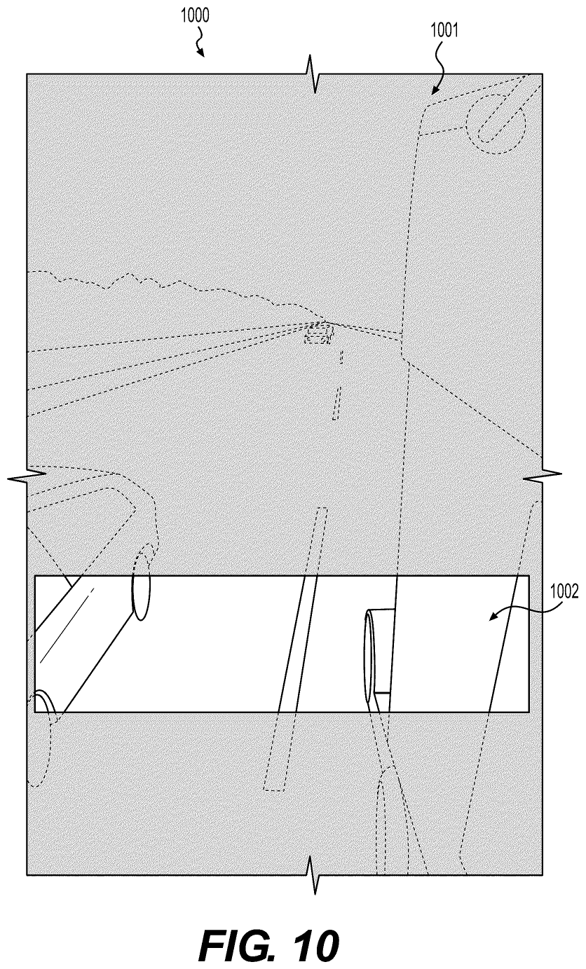

FIG. 10 depicts an enhanced view that is overlayed on a portion of a presented view that includes a region of interest, in accordance with some embodiments. As shown in FIG. 10, the enhanced view 1002 may be overlayed (e.g., embedded) within the presented view 1001 over the region of interest. The region of interest may thus be displayed as an enhanced view 1002 to a driver at the same portion of the image in which the camera records the region of interest.

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. The features of the examples disclosed in the foregoing description, in the drawings and in the claims can be essential both individually and in any combination for the implementation of the various embodiments.

### LIST OF REFERENCE NUMERALS

10—vehicle
12—Camera-wing-syetem
14—at least one camera
16—Time Of Flight (TOF) Sensor
18—Electronic Control Unit (ECU)
19—Image Section
20—Trailer/Semi-trailer/Vehicle
22—Marking Point
24—Salient Point
90—Tracking System Method
100—Method to operate a camera-wing-system
101—Steering Angle and Speed Measurement
102—Steering Angle and Speed Determination
104—Sub-Process
106—Distance Logged into Memory
108—Check to see if Ignition is on
110—Check to see if Trailer Signal is Interrupted
112—Distance to Salient Point is Measured
114—Trailer Angle Calculated
116—Trailer Angle Comparison
118—Image Section Updated
202—Trailer Type Determination
204—Determine Marking Point of Semi-Trailer
206—Determine if there is a Leading Edge
208—Helix Angle Calculated
212—Determine if there is a Sticker
214—Determine if there is a Side Light
216—Detect Wheel Axel
218—Distance to Salient Point Measured
220—Initialization
300—Semi-Trailer
302—Semi-Trailer Cab
304a—Semi-Trailer in a First Position
304b—Semi-Trailer in a Second Position
305—Leading Edge
306—mage Capturing Device
308—Salient Point
309—Central Front End of the Semi-Trailer
310—Semi-Trailer Circle of Rotation
312—Semi-Trailer Center of Rotation
400—Rigid-Trailer
402—Rigid-Trailer Cab
404a—Rigid-Trailer in a First Position
404b—Rigid-Trailer in a Second Position
406—Image Capturing Device
408—Salient Point
409—Central Front End of the Rigid-Trailer
410—Rigid-Trailer Circle of Rotation
412—Rigid-Trailer Center of Rotation
700—Method of Displaying a Presented View to a Driver
701—First Step in Method 700
702—Second Step in Method 700
703—Third Step in Method 700
704—Fourth Step in Method 700
800—Presented View
801—Surrounding Area of Presented View 800
802—Enhanced View as Picture-in-Picture (PiP) View within Presented View 800
900—Presented View
901—Surrounding Area of Presented View 900
902—Enhanced View at Boundary of Presented View
1000—Presented View
1001—Surrounding Area of Presented View 1000
1002—Enhanced View Overlayed on Presented View 1000
α—Trailer angle between distance b and distance c
α₁—Angle between distance b and the edge of the Semi-Trailer Cab
αₐ—Angle between distance c and the edge of the Semi-Trailer Cab
β—Adjustment angle or helix angel resulting from

$$β = {tan}^{- 1} \frac{{H}_{2}}{L} .$$

γ—Trailer angle between distance b and distance a
Θ—Trailer angle
a′-Distance from Center of Rotation to the rearmost end of the Semi-Trailer/Rigid-Trailer
a—Distance from Center of Rotation to the Salient Point located on the Semi-Trailer/Rigid-Trailer in the second position
b—Distance from the at least one camera to the Salient Point
c—distance from the at least one camera to the Center of Rotation
d—Distance between Center of Rotation and Central Front End of the Semi-Trailer/Rigid-Trailer
e—Distance between the at least one camera and Central Front End
bg—Distance from the Image Capturing Device to the rearmost end of the Semi-Trailer/Rigid-Trailer in the first position
va—Central Vehicle Axis
A—First distance
L—distance perpendicularly intersecting distance H, where distance L extends from the
marking point 22 to the distance H resulting from L=A sin Θ
H—distance from camera 14 to a second point along the leading edge 305 of the semi-trailer 300 in the second position
H₁—calculated distance, where H₁=A cos Θ
H₂—calculated distance, where equation H₂32 H−H₁.

1. A camera wing system for a vehicle comprising:
a camera configured to record a field of view (FOV) in an area surrounding the vehicle;
an electronic control unit (ECU) coupled to the camera, the ECU configured to determine a region of interest within the FOV; and
an image section configured to display a presented view to a driver of the vehicle, the ECU being configured to update the presented view to include the region of interest based on a driving situation of the vehicle, the presented view including an enhanced view that depicts the region of interest.

2. The camera wing system of claim 1, wherein the enhanced view is a Picture-in-Picture (PiP) view within the presented view.

3. The camera wing system of claim 1, wherein the enhanced view depicts a second view of the region of interest and is displayed at a boundary of the presented view.

4. The camera wing system of claim 1, wherein the enhanced view is overlayed on a portion of the presented view that includes the region of interest.

5. The camera wing system of claim 1, wherein the driving situation includes a lane change of the vehicle.

6. The camera wing system of claim 1, wherein the driving situation includes parking.

7. The camera wing system of claim 1, wherein the driving situation includes driving in reverse.

8. The camera wing system of claim 1, wherein the enhanced view includes a higher resolution than a surrounding area within the presented view.

9. The camera wing system of claim 1, wherein the region of interest depicted in the enhanced view is enlarged.

10. The camera wing system of claim 1, wherein a haze-removing algorithm is applied to the enhanced view.

11. The camera wing system of claim 1, wherein de-noising is applied to the enhanced view.

12. The camera wing system of claim 1, wherein the enhanced view includes a higher brightness level than a surrounding area within the presented view.

13. The camera wing system of claim 1, wherein the ECU is configured to display a boundary line surrounding an object within the enhanced view.

14. The camera wing system of claim 1, wherein the ECU is further configured to change the presented view based on a head position or an eye orientation of the driver.

15. The camera wing system of claim 1, wherein the ECU determines the region of interest based on a user input.

16. The camera wing system of claim 1, wherein the image section is updated based on a geometric calculation of a triangle including a center of rotation of a trailer of the vehicle, the region of interest, and the camera.

17. A method comprising:
receiving a video stream of a field of view (FOV) of an area surrounding a vehicle from a camera;
determining a region of interest within the FOV;
applying an image enhancement algorithm to the region of interest to form an enhanced view; and
displaying a presented view to a driver of the vehicle, the presented view including the enhanced view.

18. The method of claim 17, wherein the enhanced view is a Picture-in-Picture (PiP) view within the presented view.

19. The method of claim 17, wherein the enhanced view depicts a second view of the region of interest and is displayed at a boundary of the presented view.

20. The method of claim 17, wherein the enhanced view is overlayed on a portion of the presented view that includes the region of interest.

21. The method of claim 17, further comprising enlarging the region of interest displayed within the enhanced view.
